(19) United States
(12) Patent Application Publication
(10) Pub. No.: US 2002/0163153 A1
(43) Pub. Date: Nov. 7, 2002

(54) Prototype undercarriage

(76) Inventor: Gunther Conrad, Kalchreuth (DE)

Correspondence Address: SIDLEY, AUSTIN, BROWN & WOOD, LLP, 875 THIRD AVENUE, NEW YORK, NY, 10022, US

(21) Appl. No.: 10/106,994

(22) Filed: Mar. 26, 2002

(30) Foreign Application Priority Data
Mar. 29, 2001 (DE) 201 05 614.3

(51) Int. Cl. B60G 9/02

(52) U.S. Cl. 280/124.116; 280/124.157

(57) ABSTRACT

A prototype undercarriage, wherein an undercarriage unit is mounted on a truck base unit 2 provided for carrying a body structure 1, in that a transverse member 5 of the undercarriage unit is fastened to a counter-member of the base unit, and the transverse member 5 carries a mounting bracket 7 cast in one piece at each end, from each of which a rocker means 13 extends and in which the two rocker means 13 are cast in one piece with a rigid axle and each carry a spring means 9, 14 that is cast in one piece and situated on the side of the rigid axle opposite to the associated mounting bracket 7. In this case it is desirable, if the rocker means is a swivel mounted, separate pivot member. This is achieved in that the rocker means is a rocker member 13 separate from the mounting bracket 7, the member is mounted on the mounting bracket 7 by means of a pivot articulation 15 and is rotatable between a first position and a second position and in that the spring means are formed of a sleeve 14 and a thereinto projecting pin 9, which can be moved relative to each other and of which one is cast in one piece with the rocker 13 and the other is cast in one piece with the brace 8 extending from the transverse member 5. The undercarriage unit is formed by two and only two component parts cast or injected in one piece.

### FIELD OF THE INVENTION

The invention relates to a prototype undercarriage for a truck, in which an undercarriage unit is mounted on a base unit for carrying a body structure. A transverse beam of the undercarriage unit is fastened to a counter member of the base unit, and the transverse beam carries at each of its ends a mounting bracket cast in one piece, and with a rocker means extending from the brackets. The rocker means has two rockers each cast in one piece with a rigid axle with which the rigid axle spring means are cast in one piece.

### BACKGROUND OF THE INVENTION

In a prototype undercarriage of this type, well-known in practice, the rocker means is cast or injected in one piece with the associated mounting bracket and thus also one piece with the transverse beam. The rocker means is immobile relative to the mounting bracket. The spring component is a solid member cast overall in one piece with the rocker means and the rigid axle, and the solid member by its shape forms a well or a cylinder with a pin or rod protruding therefrom. The entire undercarriage unit is inasmuch a completely cast or injected component. On the other hand an actual truck having an actual undercarriage is well-known (Specification sheet “SAF Module SK 500” of the Otto Sauer Achsenfabrik, Keilberg),in which the rocker means is a rocker separate from a mounting bracket, which is fastened to the mounting bracket by means of a pivot joint.

### SUMMARY OF THE INVENTION

Therefore, an object of the invention is to create a prototype undercarriage of the type described above, wherein the spring means are on the one hand joined to the transverse member by one-piece casting and on the other hand are joined with the rocker means by one-piece casting, so that the rocker means is a rotational, separately mounted rocker. The prototype undercarriage according to the invention achieves the object in that the rocker means is a rocker separate from the mounting bracket and is fastened to the mounting bracket by means of a pivot joint and can be pivoted between a first position and a second position, and further in that the spring means is formed by a sleeve and pin protruding thereinto, whereby the pins and sleeves are moveable towards each other and one is cast in one piece with the rocker member and the other one is cast in one piece with the transverse beam by way of a diagonal brace.

In the prototype undercarriage according to the invention, the undercarriage unit is formed of only two part components that are each cast or injected in one piece. As a rule, the material of the undercarriage unit or the component members thereof is metal. The arrangement of the rocker articulated with the mounting bracket is achieved in conjunction with a two piece spring means formed by the sleeves and pins, whose both parts are cast or injected each with other parts of the undercarriage unit. Only the manufacture of the two rocker articulations is additional to the cost of assembly. The undercarriage unit manufactured in this manner is mounted on the base unit in the conventional manner. Because of the two-part characteristic, the additional brace is provided which serves in the fixing of the second part, the sleeves or pins, of the spring means.

It is particularly expedient if in the first position of the rocker the sleeve lies against the brace. The sleeves and the braces are thus used so as to define the initial, that is a retracted position, of the undercarriage unit.

It is likewise particularly advantageous if in the second position of the rocker a radially protruding lug provided near the pivotal articulation is applied against an interior surface of the mounting bracket. The mounting bracket and the rocker lug are thus used so as to define the second, that is an extended position, of the undercarriage unit.

It is also advantageous if the pin sits upon the brace and the sleeve on the rocker. This increases the similarity of the prototype to the reality situation.

It is further particularly expedient if the mounting bracket forms a clearance into which an articulation region of the rocker member is guidingly received on both sides. The guiding of the rocker makes the pivotable rocker more secure against tipping.

Moreover, it is particularly advantageous if the brace, on the side lying opposite to the mounting bracket, overlaps the spring member with an extension and the extension is provided with a lateral aperture for the insertion mounting of a protective plate guide. Here, too, the guiding mounting hole is provided on a single-piece cast extension of the undercarriage unit.

An advantageous embodiment of the invention is provided when two undercarriage units are arranged next to each other and the linearly arranged braces of the two undercarriage units extend into each other in a single-piece casting. The castings forming the transverse members of the two adjacent undercarriage units are thus manufactured in a common casting or injection process in one piece.

At each end of the rigid axle either one single wheel or a wheel pair is mounted. The wheels are either, apart from their rotation, immovably or pivotally mounted. There is a pendular suspension of the wheels, wherein the wheels of the undercarriage unit, on the occurrence of a depression in a lane of travel, can extend further from the base unit. The mounting of a transverse member on the counter-member is achieved, for example, by means of rivets or screws. The truck is, for example, equipped with one or two or a plurality of such undercarriages. As a rule, the rocker articulation, as viewed relative to the spring means, is arranged forward in the direction of travel.

### BRIEF DESCRIPTION OF THE DRAWING

A preferred embodiment of the invention is illustrated in the drawing, wherein:

FIG. 1 is a bottom view of a part of the prototype undercarriage of a truck; and

FIG. 2 is a side view of the undercarriage shown in FIG. 1, in a first or initial position of the rocker;

FIG. 3 is a view similar to FIG. 2 but in a second position of the rocker; and

FIG. 4 is a detail of FIG. 3 on an enlarged scale with respect to FIG. 3.

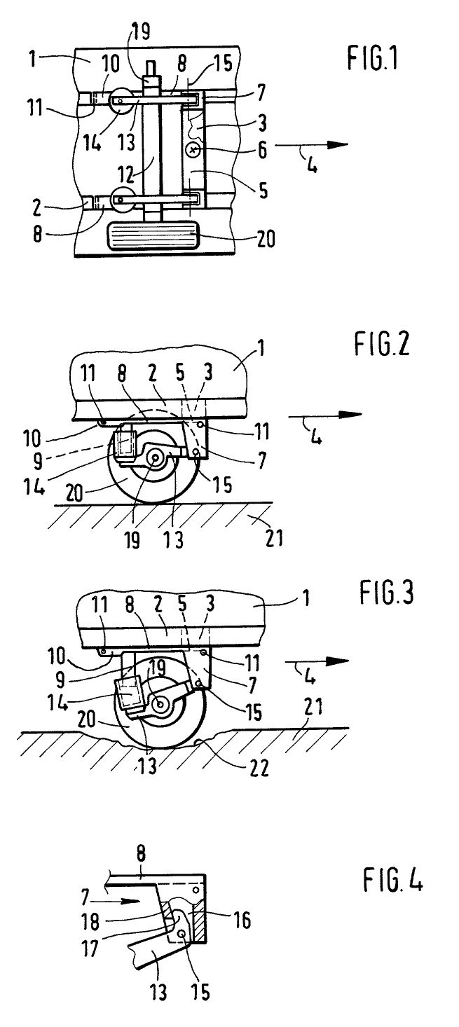

### DETAILED DESCRIPTION OF THE INVENTION

The prototype undercarriage as shown in the drawing is located on the underside of a body structure 1, which carries a longitudinal base unit 2, which forms a counter-member 3 running transversely, that is it extends at right angles to a direction of travel 4. An undercarriage unit is mounted on the base unit 2, the undercarriage unit is assembled from two component parts. One component part includes a transverse beam 5 running perpendicular to the direction of travel 4 and which is in contact with the counter-member 3 and is fastened to it by means of a screw 6. The transverse beam 5 carries on each of its ends a downwardly projecting mounting bracket 7 extending downwardly from the body structure underside and is seated on a brace 8 running parallel to the body structure underside or direction of travel, and which is in contact with the base unit 2. The brace 8 also carries a downwardly extending pin 9 extending away from the body structure underside and extends over the pin by an extension 10. In the proximity of the extension 10 and at the mounting bracket 7, part of the undercarriage unit is provided with a guiding mounting hole for the mounting of a protective plate (not shown).

The second part of the undercarriage unit encompasses a rigid axle 12, which runs parallel to the transverse member 5 and which carries an elongated rocker 13 at both of its ends, wherein the rigid axle is located approximately in a middle region of the rockers. A sleeve 14 or a well is situated in the end region of the rocker 13 located rearwardly relative to the direction of travel 4, the sleeve or well protrudes upwardly towards the body structure underside. The sleeve 14 forms a hollow cavity receiving the pin 9 with a large clearance relative to the pin. The pin 9 and the sleeve 14 form the spring means. The end region of the rocker 13 protruding in the direction of travel 4 is mounted on the associated mounting bracket 7 by means of a pivot articulation 15. In this case the forward end region, according to FIG. 4, extends into a part of the mounting bracket 7 fashioned as a clearance 16. The rocker 13 carries an extending protrusion 17 into the clearance 16, which, as shown in the positions of FIG. 3 and 4, is in contact against a wall surface 18 of the mounting bracket 7. The rigid axle 12 is provided at each of its ends with an inserted axle piece 19 onto which, in turn, a wheel 20 is mounted, which rolls in a lane 21, containing a depression 22 with the wheel pivoted downwardly into the depression.

What is claimed is:

1. A prototype undercarriage for a truck comprising an undercarriage unit mounted on a truck base unit (2) having a direction of travel (4), a counter member (3) on said base unit extending transversely of the direction of travel (4), a transverse member (5) of said undercarriage unit is secured to said counter member (3) and has two opposite ends, a mounting bracket (7) cast in one piece with and extending downwardly from said transverse member, a rocker means projecting from each of said mounting brackets (7), said rocker means comprises two rockers each cast in one piece with a rigid axle (12) extending transversely of the direction of travel (4), a spring means on each of said rockers on the opposite side of said rigid axle (12) from said mounting brackets (7) and cast in one piece therewith, said rocker means comprises rockers (13) each separate from a different said mounting bracket (7), and pivoted thereto by a pivotal articulation (15), said rockers being rotatable between a first position and a second position, said spring means comprises a pair of sleeves (14) mounted on said rockers and pins (9) each projecting into a different one of said sleeves and displaceable therein between the first and second positions, one of said sleeves and said pins (9) cast in one piece with said rockers and the other of said sleeves and said pins cast in one piece with said transverse member via a brace (8) extending in the direction of travel (4).

2. A prototype undercarriage, as set forth in claim 1, in said first position of said rockers (13) said sleeve is in contact with said brace (8).

3. A prototype undercarriage, as set forth in claim 1, wherein in the second position of said rockers (13) a radially extending projection (17) on said rocker adjacent said pivotal articulation is in contact with a surface (18) in said mounting bracket (7).

4. A prototype undercarriage, as set forth in claim 1, wherein said pins (9) are secured on said brace (8) and said sleeves (14) are secured on said rockers.

5. A prototype undercarriage, as set forth in claim 3, wherein said mounting bracket (7) forms an interior clearance (16) into which said projection (17) of said rocker is guidingly received.

6. A prototype undercarriage, as set forth in claim 1, wherein said brace (8) has an extension (10) projecting over said spring means (9,14) spaced in the direction of travel (4) from said mounting bracket (7) and said extension has a hole extending transversely of the direction of travel (4) for receiving a protective plate guide.

7. A prototype undercarriage, as set forth in claim 1, wherein two said undercarriage units are arranged adjacent to one another and cast in one piece braces (8) are aligned and extend into each other.
